(19) United States
(12) Patent Application Publication
(10) Pub. No.: US 2017/0331695 A1
(43) Pub. Date: Nov. 16, 2017

(54) COORDINATING TELECOMMUNICATIONS NETWORKS

(71) Applicant: ARIA NETWORKS LIMITED, Bath (GB)

(72) Inventors: Jay PERRETT, Chippenham, Wiltshire (GB); Omar AL ASSIL, Chippenham, Wiltshire (GB)

(73) Assignee: ARIA NETWORKS LIMITED, Bath (GB)

(21) Appl. No.: 15/531,343

(22) PCT Filed: Nov. 27, 2015
(86) PCT No.: PCT/GB2015/053635

§ 371 Date: May 26, 2017

(30) Foreign Application Priority Data
Nov. 28, 2014 (GB) 1421167.6

(51) Int. Cl. H04L 12/24

(52) U.S. Cl. CPC H04L 41/0896; H04L 41/145

(57) ABSTRACT

A system for coordinating a plurality of telecommunications networks is provided. The system comprises a first network orchestrator of a first telecommunications network and a second network orchestrator of a second telecommunications network. The plurality of telecommunications networks is described using a data model that is readable by the first and second network orchestrators and that is capable of representing connectedness and one or more of capacity and demands for service on the network. The first network orchestrator is configured to transmit a first request expressed in terms of the data model for network resources to the second network orchestrator. The second network orchestrator is configured to receive the first request for network resources, automatically determine that the requested network resources can be provided, and automatically transmit to the first network orchestrator a confirmation expressed in terms of the data model that the network resources of the first request can be provided.

### FIELD OF THE INVENTION

This invention relates to the management of telecommunications networks. In particular, the invention relates to coordinating two or more telecommunications networks in real time to ensure that data traffic flows across them efficiently.

### BACKGROUND

There is a need to manage the use of telecommunications networks for ensuring that network resources are available when required and for ensuring that network resources are used efficiently.

A range of tools has been developed by network equipment vendors for modelling the flow of traffic across networks and for managing the use of network resources. For example, Cisco and Alcatel Lucent have developed tools for managing access networks including modelling switched traffic in cities. Data centres may be modelled as networks and as a result enterprise-based custom tools for managing data centre resources have been created, for example by Hewlett-Packard Company (HP), International Business Machines Corporation (IBM) and VMWare. In order to manage traffic across nationwide core networks, Juniper and Infinera have developed tools for modelling aggregated, long haul traffic.

Each of the custom tools orchestrate the use of network resources in the networks they have been designed for. Network orchestration is the automated arrangement, coordination and management of complex computing and network infrastructure for automatically controlling computing and network resources. This approach is, however, associated with limitations because the different custom built tools use different processes and descriptions. As a result, the different network management tools do not speak to each other, and although individual networks can be managed in real time it is difficult to coordinate different networks.

Since different networks cannot easily be coordinated in real time, it is generally necessary to reserve resources in different networks in advance. This approach is often taken for broadcasting television coverage of large sporting events such as the Olympics and the FIFA World Cup. For example, in such cases it is known to build an expensive bespoke access network for media studios covering the sporting event and to reserve communication lines in a core network for distributing the media data to viewers. Network resources reserved in this way are usually unavailable to other end-users of the networks during the course of the sporting event and end-users have even been asked not to upload videos using their smartphones inside the Olympic Village. Referring to FIG. 1, known approaches are summarised schematically by a bespoke data pipe 2 built or reserved for a sporting event for transporting data from a data source 4 such as a television studio to a data centre 6 from where it is distributed to nearby viewers 8.

Following another approach, a known network capacity management tool is described in WO 2013/024269 A1, the contents of which is incorporated herein by reference.

With the limitations of known techniques in mind, it is an object of the invention to provide an improved technique for coordinating telecommunications networks.

### SUMMARY OF THE INVENTION

In a first aspect of the invention there is provided a system for coordinating a plurality of telecommunications networks is provided. The system comprises a first network orchestrator of a first telecommunications network and a second network orchestrator of a second telecommunications network. The plurality of telecommunications networks is described using a data model that is readable by the first and second network orchestrators and that is capable of representing connectedness and one or more of capacity and demands for service on the network. The first network orchestrator is configured to transmit a first request expressed in terms of the data model for network resources to the second network orchestrator. The second network orchestrator is configured to receive the first request for network resources, automatically determine that the requested network resources can be provided, and automatically transmit to the first network orchestrator a confirmation expressed in terms of the data model that the network resources of the first request can be provided.

Preferably, at least two of the telecommunications networks are different types of telecommunications networks.

Preferably, the data model comprises a data-driven network model for describing a telecommunications network.

Preferably, the data-driven network model comprises vectors and/or matrices for describing properties of the network.

Preferably, the data-driven network model comprises a description of network connectedness defined in terms of a connectedness matrix of unidirectional link identification by node identification in which matrix cells are populated by binary values.

Preferably, the data-driven network model comprises a description of network cost defined in terms of a cost of links matrix of unidirectional link identification by cost in which matrix cells are populated by cost values.

Preferably, the data model comprises a data-driven capacity model for describing capacity of a telecommunications network.

Preferably, the data-driven capacity model comprises a description of network capacity defined in terms of a capacity matrix of unidirectional link identification by bandwidth in which matrix cells are populated by bandwidth values.

Preferably, the data model comprises a data-driven service model for describing service demands on a telecommunications network.

Preferably, the data-driven service model comprises a description of demands for service defined in terms of a demand matrix of start node identification by destination node identification in which matrix cells are populated by bandwidth values.

Preferably, the second network orchestrator is configured to determine that the requested network resources can be provided by testing a network configuration based on the demand matrix.

Preferably, the orchestrators are components of a global orchestrator implemented in computer apparatus.

Preferably, the first request for network resources comprises a request for connectivity between the first telecommunications network and the second telecommunications network.

Preferably, the request for connectivity indicates a minimum bandwidth requirement.

Preferably, the first request for network resources comprises a request for data transit resources in the second telecommunications network.

Preferably, the first request for network resources comprises a request for data storage resources in the second telecommunications network.

Preferably, the data storage resources comprise data centre resources.

Preferably, the data storage resources comprise a virtual data centre.

Preferably, the data storage resources comprise a virtual cache.

Preferably, the confirmation comprises an indication of how the network resources of the first request will be provided.

Preferably, the indication defines how connectivity between the first telecommunications network and the second telecommunications network will be arranged.

Preferably, the first request for network resources is based on the first network orchestrator determining an optimum mode of operation of the first telecommunications network.

Preferably, the determining an optimum mode of operation comprises: monitoring utilisation of the first telecommunications network; determining that the first telecommunications network could be used more efficiently; and determining a more efficient mode of operation of the first telecommunications network.

Preferably, the system comprises a third network orchestrator of a third telecommunications network, wherein the second network orchestrator is configured to transmit a second request for network resources to the third network orchestrator.

Preferably, the first telecommunications network is an access network and the second telecommunications network is a core network, and the connectivity comprises connectivity for backhaul of data from the access network to the core network.

Preferably, the first network orchestrator is configured to create a virtual data centre from network resources of the first telecommunications network for storing data before backhaul.

Preferably, the first telecommunications network is a core network and the second telecommunications network is an access network, and the first request for network resources comprises a request for data storage resources in the second telecommunications network for facilitating distribution of data to end-consumers.

Preferably, the one or more requests for network resources are for broadcasting media coverage of an event to viewers globally.

Preferably, the system is configured to automatically transmit data through the networks based on the confirmation.

In a second aspect of the invention there is provided an orchestrator of a telecommunications network, the orchestrator being configured to: transmit a request for network resources to an orchestrator of another telecommunications network; receive from the orchestrator of the other telecommunications network a confirmation that the network resources of the request can be provided; and automatically control one or more components of the telecommunications network for transmitting data through the networks based on the confirmation.

In a third aspect of the invention there is provided an orchestrator of a telecommunications network, the orchestrator being configured to: receive a request for network resources from an orchestrator of another telecommunications network; automatically determine that the requested network resources can be provided; automatically transmit to the orchestrator of the other telecommunications network a confirmation that the network resources of the request can be provided; and automatically control one or more components of the telecommunications network for transmitting data through the networks based on the confirmation.

In a fourth aspect of the invention there is provided a method of coordinating a plurality of telecommunications networks, the method comprising: a first network orchestrator of a first telecommunications network transmitting a first request expressed in terms of a data model for network resources to a second network orchestrator of a second telecommunications network;

the second network orchestrator receiving the first request for network resources and automatically determining that the requested network resources can be provided; the second network orchestrator automatically transmitting to the first network orchestrator a confirmation expressed in terms of the data model that the network resources of the first request can be provided, wherein the data model describes the plurality of telecommunications networks and is readable by the first and second orchestrators and is capable of representing connectedness and one or more of capacity and demands for service on the networks.

Preferably, at least two of the telecommunications networks are different types of telecommunications networks.

Preferably, the data model comprises a data-driven network model for describing a telecommunications network.

Preferably, the data-driven network model comprises vectors and/or matrices for describing properties of the network.

Preferably, the data-driven network model comprises a description of network connectedness defined in terms of a connectedness matrix of unidirectional link identification by node identification in which matrix cells are populated by binary values.

Preferably, the data-driven network model comprises a description of network cost defined in terms of a cost of links matrix of unidirectional link identification by cost in which matrix cells are populated by cost values.

Preferably, the data model comprises a data-driven capacity model for describing capacity of a telecommunications network.

Preferably, the data-driven capacity model comprises a description of network capacity defined in terms of a capacity matrix of unidirectional link identification by bandwidth in which matrix cells are populated by bandwidth values.

Preferably, the data model comprises a data-driven service model for describing service demands on a telecommunications network.

Preferably, the data-driven service model comprises a description of demands for service defined in terms of a demand matrix of start node identification by destination node identification in which matrix cells are populated by bandwidth values.

Preferably, determining that the requested network resources can be provided comprises testing a network configuration based on the demand matrix.

Preferably, the orchestrators are components of a global orchestrator implemented a computer apparatus.

Preferably, the first request for network resources comprises a request for connectivity between the first telecommunications network and the second telecommunications network.

Preferably, the request for connectivity indicates a minimum bandwidth requirement.

Preferably, the first request for network resources comprises a request for data transit resources in the second telecommunications network.

Preferably, the first request for network resources comprises a request for data storage resources in the second telecommunications network.

Preferably, the data storage resources comprise data centre resources.

Preferably, the data storage resources comprise a virtual data centre.

Preferably, the data storage resources comprise a virtual cache.

Preferably, the confirmation comprises an indication of how the network resources of the first request will be provided.

Preferably, the indication defines how connectivity between the first telecommunications network and the second telecommunications network will be arranged.

Preferably, the first request for network resources is based on the first network orchestrator determining an optimum mode of operation of the first telecommunications network.

Preferably, the determining an optimum mode of operation comprises: monitoring utilisation of the first telecommunications network; determining that the first telecommunications network could be used more efficiently; and determining a more efficient mode of operation of the first telecommunications network.

Preferably, the method comprises a third network orchestrator of a third telecommunications network, wherein the second network orchestrator is configured to transmit a second request for network resources to the third network orchestrator.

Preferably, the first telecommunications network is an access network and the second telecommunications network is a core network, and the connectivity comprises connectivity for backhaul of data from the access network to the core network.

Preferably, the first network orchestrator is configured to create a virtual data centre from network resources of the first telecommunications network for storing data before backhaul.

Preferably, the first telecommunications network is a core network and the second telecommunications network is an access network, and the first request for network resources comprises a request for data storage resources in the second telecommunications network for facilitating distribution of data to end-consumers.

Preferably, the one or more requests for network resources are for broadcasting media coverage of an event to viewers globally.

Preferably, the method comprises automatically transmitting data through the networks based on the confirmation.

In a fifth aspect of the invention there is provided computer program code which when run on a computer causes the computer to perform a method according to the fourth aspect.

In a sixth aspect of the invention there is provided a carrier medium carrying computer readable code which when run on a computer causes the computer to perform a method according to the fourth aspect.

In a seventh aspect of the invention there is provided a computer program product comprising computer readable code according to the fifth aspect.

In an eighth aspect of the invention there is provided an integrated circuit configured to perform a method according to the fourth aspect.

In a ninth aspect of the invention there is provided an article of manufacture for detecting a selected mode of household use, the article comprising: a machine-readable storage medium; and executable program instructions embodied in the machine readable storage medium that when executed by a programmable system causes the system to perform a method according to the fourth aspect.

In a tenth aspect of the invention there is provided a device for detecting a selected mode of household use, the device comprising: a machine-readable storage medium; and executable program instructions embodied in the machine readable storage medium that when executed by a programmable system causes the system to perform a method according to the fourth aspect.

In an eleventh aspect of the invention there is provided a method of a first orchestrator of a first telecommunications network coordinating use of the first telecommunications network with use of a second telecommunications network, the method comprising: the first orchestrator transmitting a request for network resources to an orchestrator of the second telecommunications network; the first orchestrator receiving from the orchestrator of the second telecommunications network a confirmation that the requested network resources can be provided; and the first orchestrator automatically controlling one or more components of the telecommunications network for transmitting data through the networks based on the confirmation.

In a twelfth aspect of the invention there is provided a method of a first orchestrator of a first telecommunications network coordinating use of the first telecommunications network with use of a second telecommunications network, the method comprising: the first orchestrator receiving a request for network resources from an orchestrator of the second telecommunications network; the first orchestrator determining that the requested network resources can be provided; the first orchestrator transmitting to the orchestrator of the second telecommunications network a confirmation that the requested network resources can be provided; and the first orchestrator automatically controlling one or more components of the telecommunications network for transmitting data through the networks based on the confirmation.

### DESCRIPTION OF THE DRAWINGS

The invention will now be described in detail with reference to the following drawings of which:

FIG. 2 is a schematic diagram of telecommunications networks connected together, each network having an orchestrator according to an embodiment of the invention;

FIG. 3 is a schematic diagram of the orchestrators of FIG. 2 showing lines of communication between them;

FIG. 4 is a block diagram of two of the orchestrators of FIG. 2 showing a network data model being exchanged between them and modules for network management inside each of them;

FIG. 5 is a flow chart showing a method of coordinating a plurality of networks for transporting data according to an embodiment of the invention;

FIG. 6 is a schematic diagram of the telecommunications networks of FIG. 2 showing an example use case in which the orchestrators are coordinated for transporting data relating to a sporting event to viewers according to the method of FIG. 5;

FIG. 7 is a flow chart summarising the implementation of the use case of FIG. 6;

FIGS. 8A, 8B and 8C are, respectively, a network diagram, a matrix and a vector illustrating an example data structure for describing a telecommunications network in accordance with an embodiment of the invention;

FIG. 9 is a flow chart showing a method of computing an optimum set of routes across a network in accordance with an embodiment of the invention;

FIG. 10 is a flow chart showing a method of evolving a routing solution towards an optimum set of routes in accordance with the method of FIG. 9; and

FIG. 11 is a functional block diagram of a computer system suitable for implementing one or more of the orchestrators of FIG. 2.

Throughout the drawings, like reference symbols refer to like features or steps.

### DETAILED DESCRIPTION OF THE INVENTION

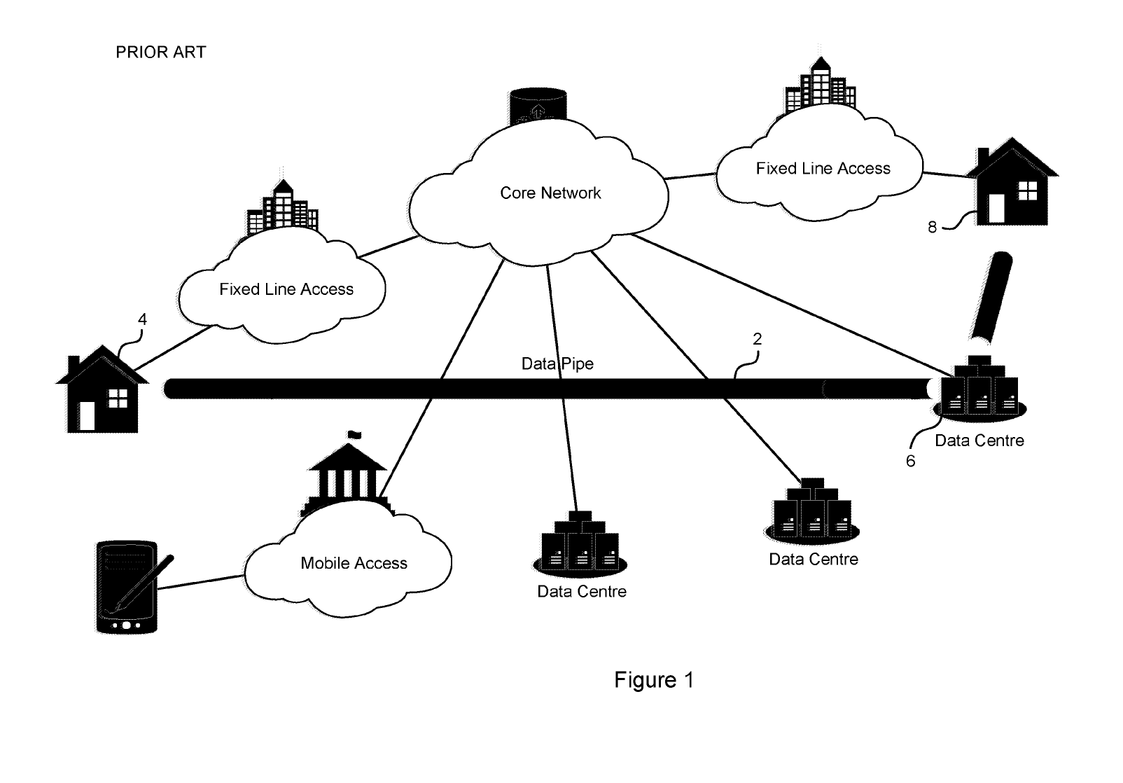

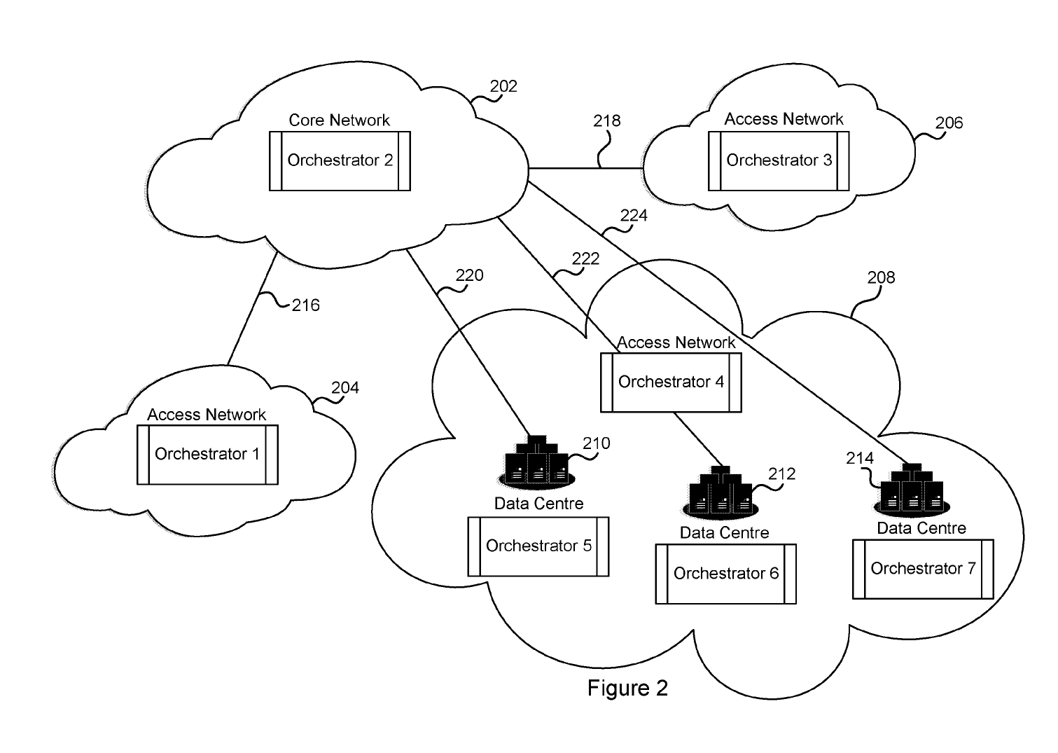

Referring to FIG. 2, a core network 202 is connected to three access networks 204, 206 and 208 for transporting data between them in accordance with an embodiment of the invention. In this example, the core network 202 is the core part of a telecommunication network of a service provider, and each of the access networks 204, 206 and 208 connects subscribers to the service provider.

The access network 204 has an orchestrator, Orchestrator 1, which performs network management functions in relation to the access network 204, as will be described in more detail below. Similarly, network management functions for the core network 202 and the access network 206 are provided by Orchestrator 2 and Orchestrator 3, respectively. The access network 208 has a different arrangement because it includes three data centres 210, 212 and 214, each of which is housed in a respective data centre building in a different location. The access network 208 is managed by Orchestrator 4, but each of the data centres 210, 212 and 214 located within the access network 208 is independently managed by Orchestrator 5, Orchestrator 6 and Orchestrator 7, respectively.

The access network 204 has connectivity 216 to the core network 202, as shown in FIG. 2. The access network 206 similarly has core connectivity 218. Each of the data centres 210, 212 and 214 of the access network 208 have core connectivity 220, 222 and 224, respectively, provided by the access network 208.

The core connectivity of each of the access networks 204, 206 and 208 enables data traffic to be transported from one network to another, and enables the seven orchestrators to exchange data between them.

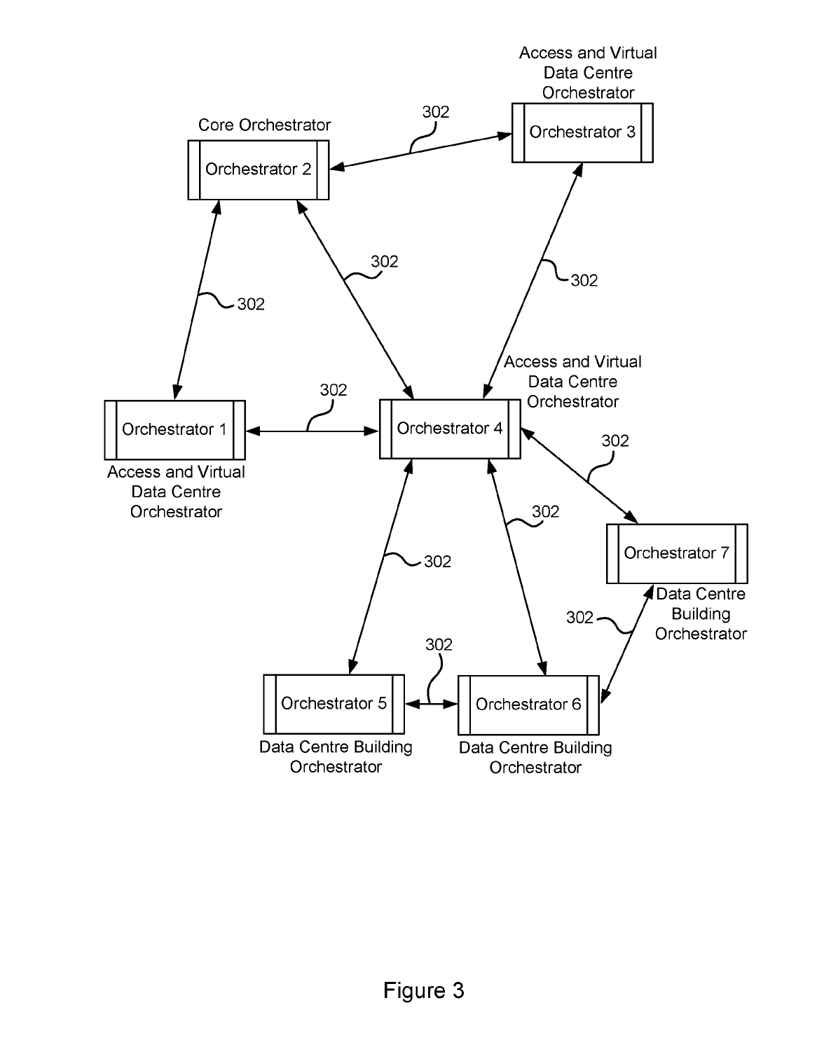

Each of the orchestrators is connected to the network it orchestrates, and through that network may communicate with other orchestrators. For example, Orchestrator 3 of the access network 206 may communicate with Orchestrator 2 of the core network 202 via the core connectivity 218 of the access network 206. Similarly, Orchestrator 4 may communicate with Orchestrator 7 of data centre 214 by communications within the access network 208 and may also communicate with Orchestrator 2 through core connectivity of the access network 208. In an alternative arrangement, the orchestrators may communicate with each other through a separate control plane. In either case, the ability of the orchestrators to communicate with each other may be expressed as the orchestrators being networked together. Such a networking of the seven orchestrators is shown in FIG. 3 in which orchestrator connections 302 represent the ability of two orchestrators being able to communicate with each other.

As indicated in FIG. 3, Orchestrator 2 may be referred to as a core orchestrator because it is an orchestrator of the core network 202. Similarly, Orchestrators 5, 6 and 7 may be referred to as data centre orchestrators because they manage the data centres 210, 212 and 214. Orchestrators 1, 3 and 4 may be referred to as access and virtual data centre orchestrators because they manage the access networks 202, 206 and 208, respectively, but may also manage virtual data centres that are established within those access networks, as will be described further below.

Each of the seven orchestrators performs a range of network and capacity management functions in respect of its own network. For example, each of the Orchestrators 1 to 7 of FIGS. 2 and 3 performs network management functions for managing its network—either the core network, one of the access networks, or one of the data centres. The different network management functions are reflected by the different modules of the orchestrators, where each module plays a distinct role in the overall management of the network.

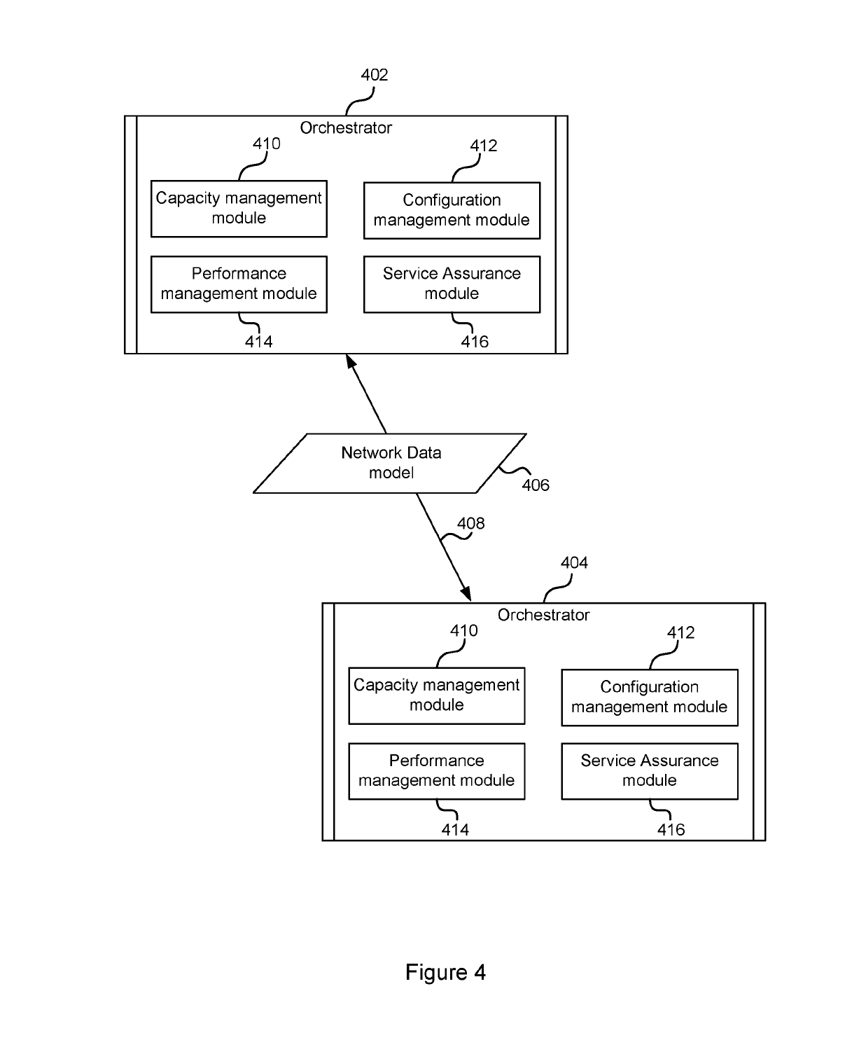

Referring to FIG. 4, example orchestrators 402 and 404 represent the Orchestrators 1 to 7. The example orchestrators 402 and 404 are presented to illustrate the different modules of an orchestrator and the roles that each of those modules plays.

The example orchestrators 402 and 404 each comprise four modules for managing their networks using data-driven network models. The orchestrators 402 and 404 may also communicate with each other by exchanging data 406 through an orchestrator connection 408. As shown in FIG. 4, each orchestrator 402, 404 has a capacity management module 410, a configuration management module 412, a performance management module 414 and a service assurance module 416.

The capacity management module 410 is used for optimising the use of network resources so that available resources are used efficiently. The capacity management module 410 has access to an inventory of network equipment including physical resources and logical resources. The physical resources may include physical network items such as routers, switches and optical fibre. Logical resources are functions created from physical resources which are defined in software and may be geographically distributed. For example, logical resources may include a virtual private network (VPN), a virtual data centre (VDC), and a virtual cache.

The configuration management module 412 is related to the capacity management module 410 and manages how resources are configured. For example, the configuration management module 412 may manage how a router is configured—for example how many network links it is connected to, how much bandwidth it provides, or, if is an optical device, how many wavelengths or channels it is configured to provide.

The performance management module 414 is for monitoring the usage of physical and logical resources on the network. Thus, the performance management module may monitor how much traffic is travelling across a particular link of the network—i.e. the utilisation of the link. The performance management module 414 may also monitor other aspects of the use of the network such as how many copies of a data set are being transmitted across the network.

The service assurance module 416 uses data from the other three modules to perform checks that current arrangement and use of the network enable service level agreements (SLAs) to be met. SLAs comprise agreed quality of service (QoS) metrics such as packet loss, jitter and bandwidth.

The orchestrators 402, 404 coordinate the use of their networks by calculating an optimum operating mode for their own network and checking that the impact of this on the other orchestrator's network is acceptable. Thus, a negotiation takes place between the orchestrators 402, 404 for optimising the mode of operation of both networks, including arranging the operation of one network to facilitate optimum operation of the other. The orchestrators 402, 404 perform negotiations by exchanging information using a data driven model they can both read. The data driven model provide generic definitions of the networks, their capacity and demands placed on the networks.

For example, the orchestrators 402, 404 may coordinate their networks for broadcasting a sporting event to multiple scheduled viewers. In this example, a television studio providing coverage of the sporting event provides data to the network managed by the orchestrator 402. Scheduled viewers of the sporting event are connected to the network managed by the orchestrator 404. As a result, in order to optimise the use of the two networks for transporting the data from the television studio to the scheduled viewers, the orchestrators 402, 404 perform a negotiation to coordinate their networks.

In this approach, the orchestrator 402 may determine that in an optimum mode of operation its network would transmit just a single copy of the data from the television studio rather than multiple copies, and let the other network generate multiple copies and manage their distribution to the scheduled viewers. In this instance, the orchestrator 402 transmits a request to the other orchestrator 404 to propose this arrangement. In particular, the request may indicate that a predetermined quantity of data is to be provided, that a predetermined bandwidth of connection is to be reserved between the networks, and that a cache should be provided in the other network for storing the data before it is distributed to the scheduled viewers.

The orchestrator 404 receives the request and determines an optimum mode of operation of its network that delivers the requested services. The orchestrator 404 determines optimum data transit resources and data storage resources for delivering the request. For example, in order to provide the storage function, the orchestrator 404 may determine that a virtual cache may be provided using the resources available in its network. The orchestrator 404 checks that the determined optimum mode of operation still meets its SLAs and confirms to the orchestrator 402 that its request can be met.

In this example, the orchestrator 402 requests network resources from the orchestrator 404 because a need to broadcast the sporting event efficiently across two networks is anticipated. In other examples, a need may be identified by monitoring traffic on a network and reacting to provide a more efficient mode of operation, rather than anticipating a scheduled need and arranging the networks appropriately in advance.

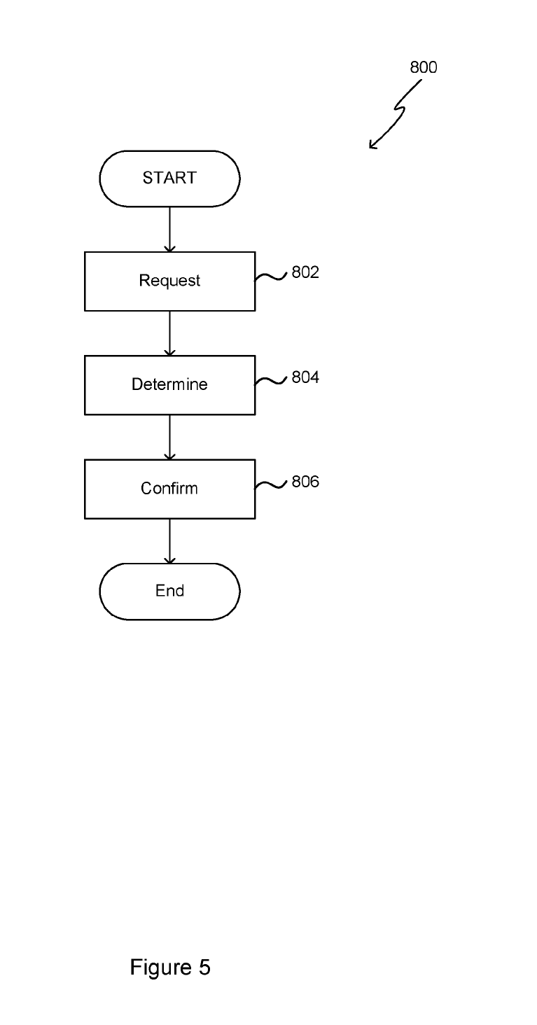

In either case, a negotiation between two orchestrators for coordinating their networks involves the following steps. Referring to FIG. 5, a requesting orchestrator requests network resources for data transport from a responding orchestrator (step 802). The responding orchestrator determines whether the requested services can be provided (step 804) and, if they can, confirms to the requesting orchestrator that the request can be met (step 806).

This negotiation process is used by the Orchestrators 1 to 7 of FIGS. 2 and 3 for coordinating their respective networks and data centres. For example, the Orchestrators 1 to 7 may negotiate network and data centre resources for providing an optimum solution for global data transport. Large sporting events provide an example of this situation because the event takes place in a single location but there are viewers all over the world.

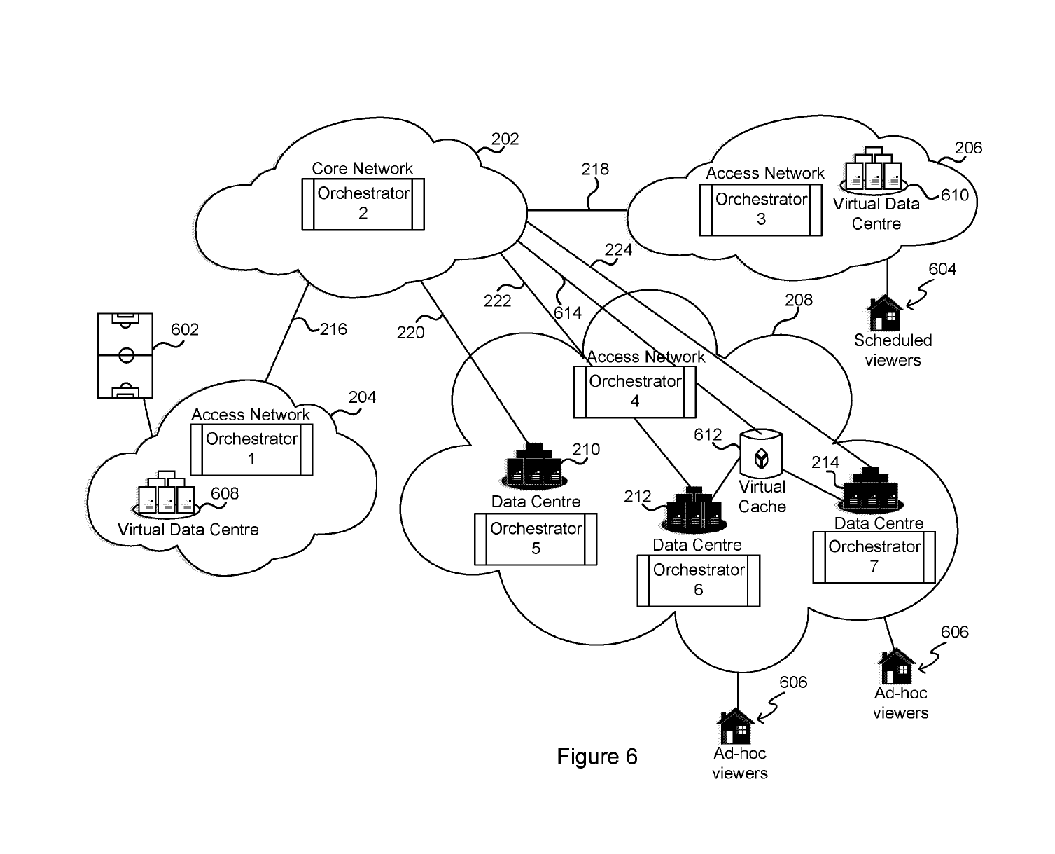

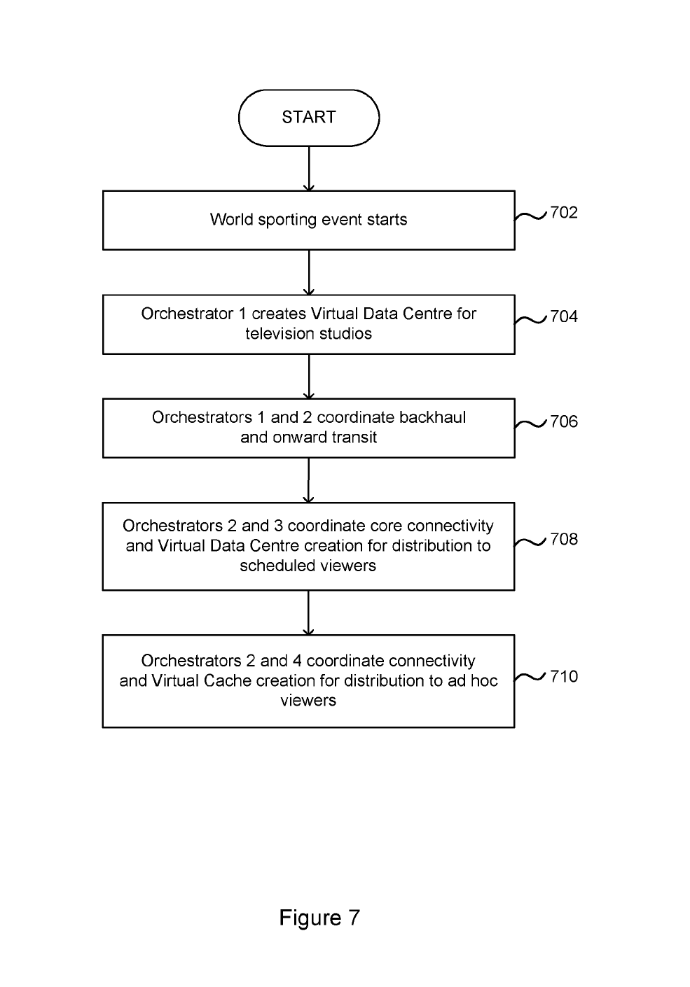

Referring to FIGS. 6 and 7, in an example the Orchestrators 1 to 7 coordinate network resources for broadcasting the FIFA World Cup 602. The event 602 is held in an originating country and there are scheduled viewers 604 and ad hoc viewers 606 around the world. When the event starts (step 702 in FIG. 7), television studios in the originating country film the sporting event 602 and provide media data to the access network 204.

Orchestrator 1 arranges the establishment of a virtual data centre 608 using resources of the access network 204 (step 704) so that the media data can be stored in the virtual data centre 608 before being backhauled to the core network 202 for onward transit. In a virtual data centre, the instances of components of a data centre are created in software on generic computer equipment including storage and compute resources. The components may, for example, include firewalls, load balances, routers, encryption functionality, and session management functionality constructed created in software using units of available generic storage and compute resources. Thus, the virtual data centre 608 is constructed in software from physical resources in the originating country and may be geographically distributed within the originating country.

The backhaul of the media data to the core network 202 is coordinated by Orchestrators 1 and 2 (step 706). Orchestrator 1 determines an optimum mode of operation of the access network 204 for transmitting the media data from the virtual data centre 608 to the core network 202, and determines that core connectivity of a sufficient bandwidth is required for transporting the media data to the core network 202. Orchestrator 1 generates a request for core connectivity and onward transit and forwards the request to Orchestrator 2. Part of the request is for coordinating onward transit of the media data (step 706) and as such Orchestrator 1 provides an indication in the request of the final destination of the media data where known. For the scheduled viewers 604 the final destination is known so this is possible. An indication that the media data is destined for access network 206 for distribution to the scheduled viewers 604 is included in the request. The request may be expressed in terms of a demand matrix. In the following example demand matrix, a source of traffic is indicated as being a ‘router 1’ of a virtual data centre (VDC) in the access network 204, the destination is indicated as being the access network 206, and the SLA parameters are indicated as being 120 Gb of bandwidth together with other SLA parameters such as packet loss and jitter (not shown).

| | | | SLA |
|---|---|---|---|
| Source network | Source router | Ultimate destination | parameters |
| Access Network 204 | Router 1, VDC | Access Network 206 | 120 Gb; . . . |

Orchestrator 2 receives the request. In this example, there are three questions Orchestrator 2 answers in response to the request. Firstly, core connectivity is provided for the media data to be sent from access network 204 to the core network 202. Secondly, optimum available transit resources are identified and reserved for transporting the media data across the core network 202 from the originating access network 204 to the destination access network 206. Thirdly, connectivity between the core network 202 and the destination access network 206 is reserved for providing the media data to the destination access network 206, and storage facilities are established in the access network 206 for facilitating the distribution of the media data to the scheduled viewers 604.

Reserving core connectivity for backhaul and transit resources within the core network 202 is performed by Orchestrator 2. In contrast, the coordination of connectivity to the access network 206 and storage facilities in the access network 206 for facilitating distribution to the scheduled viewers 604 is performed as a collaboration (step 708) between Orchestrators 2 and 3.

As part of the collaboration, Orchestrator 2 generates and sends a request for connectivity, storage facilities and transit resources to Orchestrator 3. Again, the request may be expressed in terms of a demand matrix. The request indicates the required connectivity bandwidth, the locations and numbers of scheduled viewers, and that a virtual data centre 610 is requested. A virtual data centre 610 may be requested if it is cheaper to transport a single copy of the media data to the virtual data centre 610 and distribute from there, rather than transporting multiple copies into and across the access network 206 for multiple scheduled viewers 604. An optimum mode of operation for access network 206 is determined by Orchestrator 3 for providing these resources and a response, which may comprise an ‘Ack Message’ indicating that the data resources have been reserved, is sent from Orchestrator 3 to Orchestrator 2 confirming that the request can be met. If the full resources cannot be met then those available would be returned.

Having received confirmation from Orchestrator 3 that onward transit, storage and distribution resources have been reserved in the access network 206, and having reserved optimal backhaul and transit resources in the core network 202, Orchestrator 2 responds to the original request from Orchestrator 1 confirming that the media data can be transported to the scheduled viewers 604.

During the course of the event 602 the media data generated in the originating country is transported to viewers around the world using the multiple telecommunications networks. For the scheduled viewers 604, transmission resources are reserved and the amount of traffic is likely to be supported by the reserved resources. However, significant numbers of ad hoc viewers may want to watch certain matches of the FIFA World Cup in a pattern that was not anticipated. In this instance, orchestrators of the affected networks may react to the demands in real time and coordinate the use of their networks to improve the efficiency with which the media data is distributed to the ad hoc viewers.

For example, referring to FIG. 6, there are ad hoc viewers 606 connected to the access network 208. Multiple copies of the media data are sent from the core network 202 through connections 220, 222 and 224 to data centres 210, 212 and 214 respectively of the access network 208. The transit across the core network 202 of multiple copies going to the access network 208 is detected by Orchestrator 2 which determines that it would be an improvement to send fewer copies to the access network 208. Orchestrator 2 therefore generates and sends a request to Orchestrator 4 for caching functionality in access network 208 (step 710). Orchestrator 4 receives the request and determines that an optimal arrangement would involve a virtual cache 612 created in software from data centres 212 and 214 for onward distribution to the ad hoc viewers 606, and a single connection 614 from the core network 202 to the virtual cache 612. A reply is generated by Orchestrator 4 and sent to Orchestrator 2 confirming that the caching request can be met and the improved arrangement is implemented.

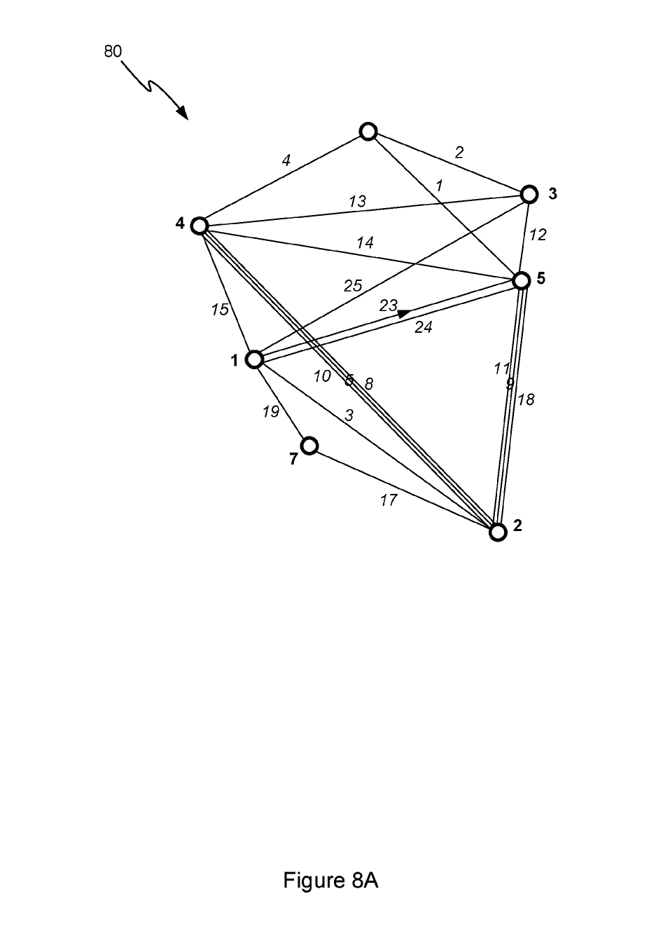

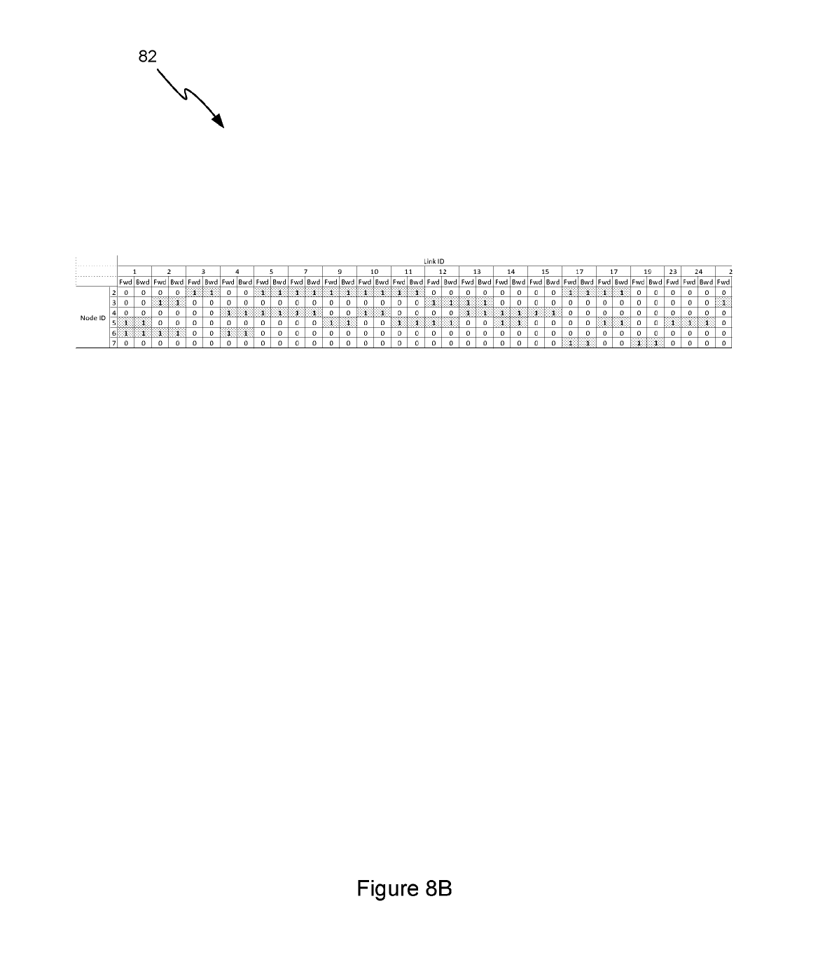

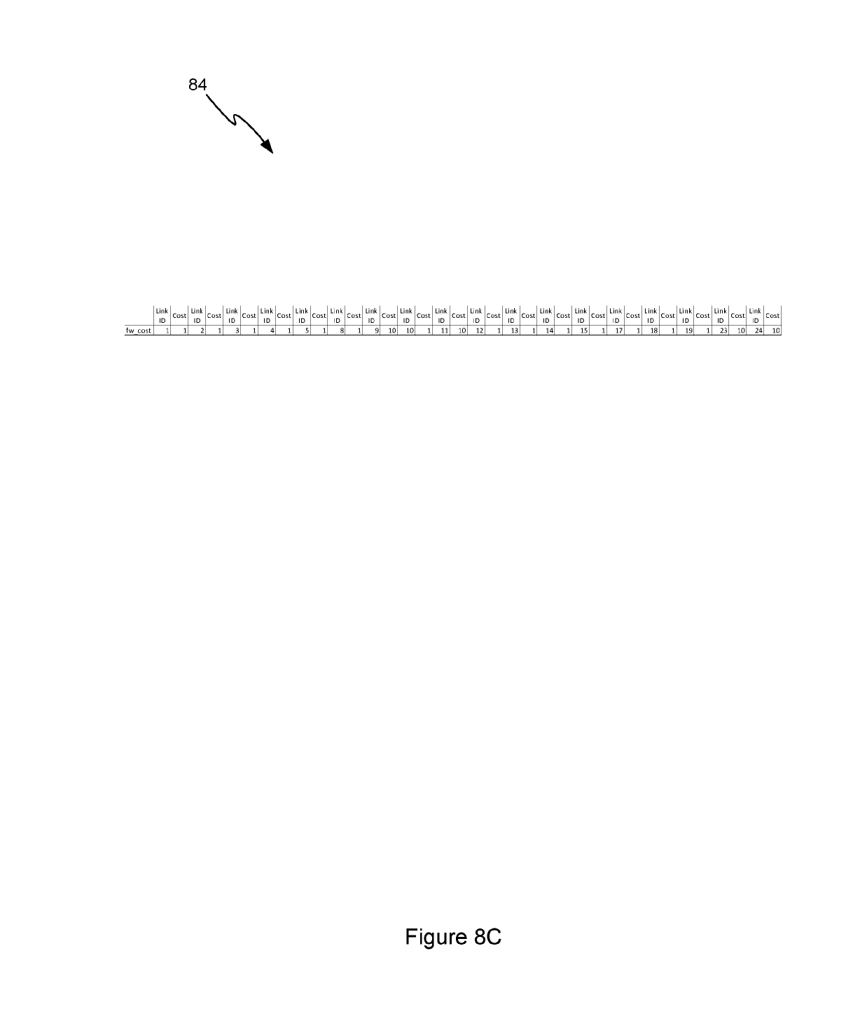

In the described embodiments, the orchestrators use a data-driven model for describing their networks. The data-driven model comprises a predefined data structure for describing for example the connectivity of the networks, the capacity available on the networks, and the service demands being placed on the networks. For example, properties of the network 80 shown in FIG. 8A may be described by numbering the nodes 1 to 7 (shown as circles) and the links 1 to 25 (shown as straight lines connecting the circles). Using this numbering, properties of the network may be expressed in the form of vectors and matrices which the routing engines can use as inputs for routing computations. For example, referring to FIG. 8B, a connectedness matrix 82 describing the network 80 has columns for links and rows for nodes. There is a column for each unidirectional link. As a result, each bidirectional link is represented by two columns—‘Fwd’ and ‘Bwd’—and each unidirectional link, such as link 23, is represented by a single column—‘Fwd’. The cells of the matrix take values of zero or one depending on whether the link of the column is connected to the node of the row. For example, referring to the forward direction of link 1 (i.e. the first column), the cells taking a value of 1 are in the rows for nodes 5 and 6. This indicates that the forward direction of link 1 connects nodes 5 and 6. Taking the forward direction of link 3 as another example, a value of 1 is taken by the cell in the row representing node 2. There are no other cells in this column that take a value of 1 but this implies that the other end of the forward direction of link 3 is connected to node 1 which is not represented by a row in the matrix 82. Thus, the matrix 82 fully represents the connectedness of the network 80 using a number of rows that is one fewer than the number of nodes.

Other properties of the network 80 may be similarly represented by other matrices or vectors. For example, the cost of each of the links may be represented by a vector 84 as shown in FIG. 8C. In the vector 84 the values taken by the elements of the vector are a link identifier (ID) followed by an indication of the cost of the identified link, followed by another link ID and then the cost of that other link, and so on. Alternatively, a similar link cost vector could simply include values of the links in a predefined order—thus taking the form [c₁, c₂, c₃, . . . ]. Other properties of the links, such as capacity and utilisation, may similarly be represented by vectors.

Vectors are also used to represent the properties of nodes—for example, the capacity of a node, the physical location coordinates of a node, the Internet Protocol (IP) address of a node, and whether a node is exempt from protection.

Properties of a set of services S1 to Sn may be represented by a vector—for example by listing the values of properties such as the maximum delay, required bandwidth and network layer of each of the services in a predefined order. The routes taken by services S1 to Sn across a network may be represented by matrices either with reference to the links of the network or to the nodes of the network. For example, a matrix with a row for each service and a column for each link will have a 1 in a cell if that service uses that link, and a zero if it does not. Similarly, a matrix with a row for each service and a column for each node can define routes taken by each of the services by indicating for each service whether or not the node is used. Primary and secondary routes, as well as point-to-point services and point-to-multipoint services and IP flows can be represented by matrices in this way.

A vector may also be used to represent a series of properties of the network 80 as a whole. For example, properties such as whether load balancing is allowed in the network, adjacency limit (i.e. the maximum number of links that can be connected to a single node), and total network utilisation may be listed in a predetermined order to form a vector describing a network. A modelling vector may be similarly defined to describe rules for network modelling. For example, parameters used in evolving an optimal routing solution (described in more detail below) could for example include parameters for defining an asymptote, parameters defining predetermined weights for mutations, and a parameter defining genepool size (these terms are defined below). It will be apparent that any suitable routing engine could be used to generate candidate routes leading to an optimised solution.

This data structure can be used for calculating properties of the network 80 and services S1 to Sn. For example, a dot product of a link utilisation vector indicating the fractional utilisation of the capacity of each link and a link capacity vector indicating the total capacity of each link will produce a scalar value representing the total network utilisation. Since the values taken by the elements of the vectors and matrices are binary, the data structure requires very little memory for storing and computing properties of the network and services. The nature of the data structure also makes it very straight forward to add further information such as other properties of the links and nodes because the data structure is predefined.

The data-driven model can provide a generic representation of a telecommunications network that is common for different data transport technologies, in which case the model can be instantiated for the technology mix under consideration and a generic routing product can be applied for computing routing solutions for the data transport technologies of the mix. This approach brings together information technology (IT)—e.g. data centres—and telecommunications—e.g. radio and fibre optics—for network management that is coordinated across the technology mix.

Not only can different technology types, such as different layers of a network, be modelled using the data structure, but also different geographical aspects of a network can be modelled. For example, at a highest level of abstraction, an intercity telecommunications network can be represented in which each node represents a large city or other large point of presence (POP) and each link represents an intercity right of way, duct or existing cabling. At the next level of detail, a separate network model can be used to represent the routers, optical devices, and IP and optical links of a city. At the next level of detail, another network model can be used to represent a data centre as a network of aggregation switches, top of rack routers, firewalls, load balancers and other data centre devices.

It will be appreciated that by simply changing the data, the network model can be rapidly and easily configured and reconfigured. This is possible because the different networks (IP layer, optical layer, intercity, city, data centre, etc) share the same structural principles but differ in the data needed to instantiate them. This enables common modelling of different technologies and different scales of interest, as well as computing interactions between the network layers and city and intercity networks. The data structure is also suitable for modelling a virtual network—i.e. a geographically distributed, software defined network (SDN).

Described embodiments of the invention use a data driven representation of capacity. In this context, a capacity is defined as a unit on the network which may be consumed. For example, a capacity could be a unit of bandwidth, a port, a wavelength (i.e. channel), a unit of power, and so on. Consumable units can also be provided by virtual SDN enabled devices such as a virtual firewall or virtual router. Since capacities are consumed according to usage patterns, for example with the consumption of one type of capacity depending on or implying the consumption of another type of capacity, capacities are related to each other by various relationships such as parent-child relationships, consequential relationships and disjoint relationships. To represent this, capacity groups are defined for representing a related group of capacities on the network and for describing how they are related and how they are consumed. Some capacity groups are node capacity groups and could for example describe the consumable items in an IP/optical rack with multiple ports, input cables and output cables. Other capacity groups are link capacity groups and similarly describe the consumable items associated with the link, such as power for signal boosting, channels or wavelengths, capacity on certain channels, and so on. This embodiment also uses ‘capacity group templates’ comprising rules for creating capacity group instances including rules for how the different capacity types are consumed. To represent a capacity group, a suitable capacity group template is populated by instance data. The language for defining a capacity group template is rich enough to describe all the possible capacity relationships. As capacity or capacity type in a capacity group template can include cost (relative or real), economic modelling can also be performed.

Demands for services on the network are represented by populating service consumption templates by instance data. A ‘service’ is defined here as a vehicle to consume capacity and not necessarily an end user service. For example, services may include an aggregated digital subscriber line (DSL) load, a virtual machine (VM), a virtual network function (VNF), access trunk link capacity, or service chains. A ‘service consumption template’ describes a service type and how this service type consumes capacity from the available capacity groups. Usually a service type consumes capacity from multiple capacity groups. The Capacity group template is responsible for associating other relative capacities from that the service requests, e.g. a service may require 100 Mb link capacity but to provide this the Capacity Group Template will provide the total link capacity, e.g. 1 Gb, 1 G client port, 10 G WAN port, shelves, chasses, rack space, power etc.

In the described embodiment of the invention, instance data is used to populate the data structure including capacity and service consumption templates, and each orchestrator uses an instance of the data structure for modelling its network. The data model is also used by the orchestrators for communicating with each other and thus the data model provides a common data schema among the orchestrators. It is with the use of this common data schema that the orchestrators transmit requests for services or network resources to each other and confirm that network resources can be provided.

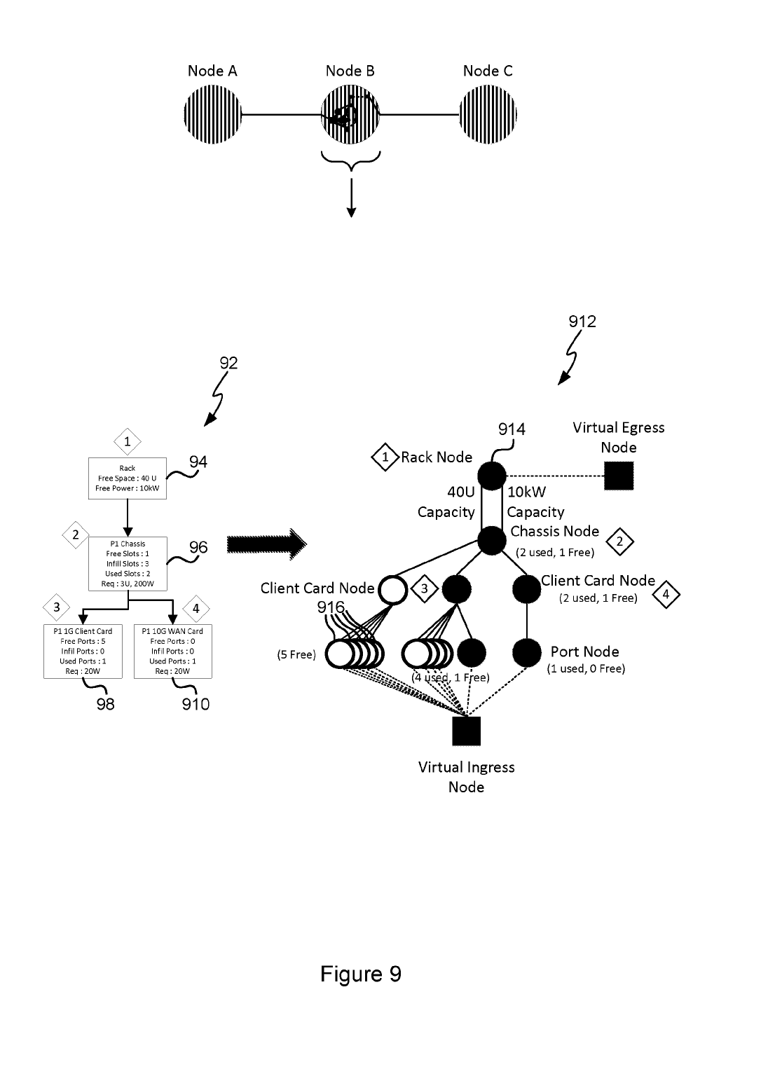

An example of a capacity and service requirement template 92 populated by instance data for describing a node B of a network is shown in FIG. 9. The template 92 has a hierarchical structure with a representation 94 of a network rack at the top of the hierarchy. The rack representation 94 indicates a rack having 40 U of free space, where ‘U’ is a standard unit of space meaning 1.75 inches of height within the rack. The rack also has 10 kW of free power for running general rack facilities such as electrical fans to control the temperature inside the rack.

The template also includes a representation 96 of a P1 chassis inside the rack, requiring 3 U of space and 200 W of power, and having two used slots. Representations 98 and 910 indicate client cards occupying the two used slots. For example, representation 98 illustrates a 1 G client card having five free ports and one used port, and requiring 20 W power.

The template 92 can also be expressed in the form of a network model 912, as shown in FIG. 9. Here, different items in the hierarchical structure are represented by different nodes of a network model. For example, a rack node represents the rack having 40 U of space and 10 kW of free power. Similarly, the five free ports of the 1G client card are represented by the five nodes 916.

By representing a capacity and service requirement template using a network model, the capacity and service requirements of a node such as a rack may be described using the vectors and matrices of the data scheme described above.

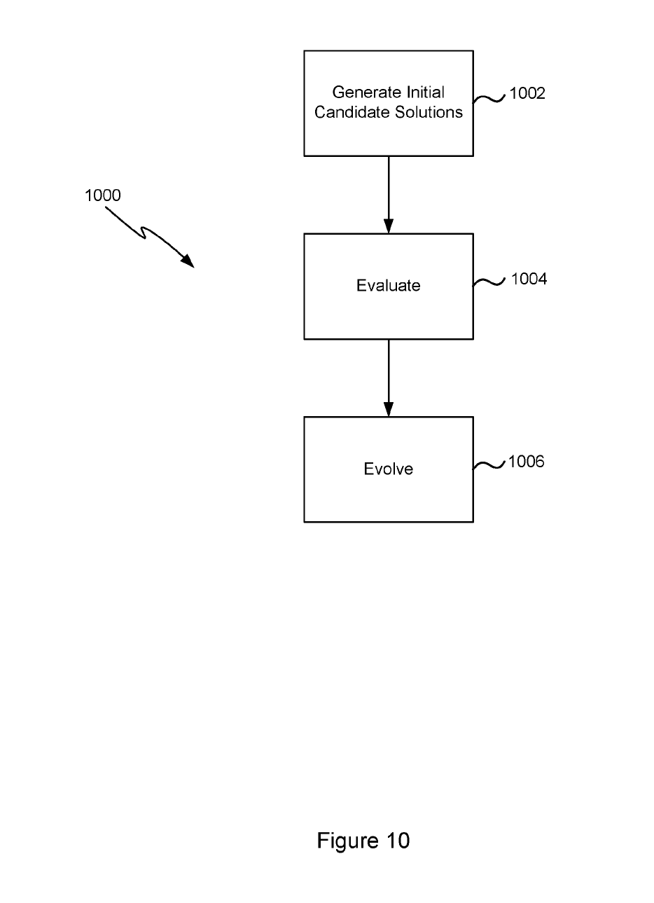

Each orchestrator determines an optimum mode of operation of its network using one or more generic routing engines that perform computations on a network model expressed using the above-described data structure. Referring to FIG. 10, the optimisation process is an iterative process that starts with an initial set of candidate solutions for routing traffic through the network and evolves the set of solutions towards an optimised solution. According to a method 1000 of determining an optimum set of routes, a set of candidate solutions for starting the process is generated at step 1002. Each candidate solution comprises a set of routes or paths across the network being modelled, their being one path in each set for each respective service requirement of a demand matrix. Thus, each candidate solution offers a potential routing plan for the services of the demand matrix and can be evaluated with respect to the network and to the demand matrix to determine the quality of the solution. Each of the initial candidate solutions is evaluated at step 1004 by computing a fitness function whose value indicates how well the candidate solution meets the requirements of the network and of the demand matrix. This enables the candidate solutions to be compared with each other, for example by ranking them in order of fitness, to establish which candidate solutions are strongest and which are weakest.

The initial set of candidate solutions, which may for example contain five hundred candidate solutions, is evolved at step 1006 towards an optimum solution. This is achieved using an iterative approach that directs the development of the set of candidate solutions towards an optimum. In each iteration, the weakest candidate solutions—i.e. those with the lowest fitness function values—are replaced by new candidate solutions provided that the new candidate solutions have higher fitness functions than the weakest candidate solutions. This tends to increase the quality of the set of candidate solutions as the number of iterations increases, thereby evolving the set so that it becomes increasingly likely that the set includes the optimum solution.

The fitness function may provide a measure of one particular performance parameter, such as bandwidth, or alternatively may take account of two or more performance parameters, for example bandwidth, protection, latency and cost. If there are multiple performance parameters to be evaluated, the fitness function may take account for their relative importance, for example by using weighting coefficients.

To evaluate cost, the fitness function may comprise a function of the difference between the total cost of all routes of a candidate solution and the total budget indicated by a customer. To evaluate latency, the fitness function may comprise a function of the mean difference between delivered latency and requested maximum latency of all routes of a candidate solution. Both these could also be just minimised or if the property was something that needed to bigger to be better, e.g. optical signal to noise ratio (OSNR), could be maximised. Another example of a performance parameter that may be evaluated is disjointedness. Disjointedness is a measure of how many nodes or links of a candidate solution are shared between different paths of the candidate solution. For example, to evaluate disjointedness, a fitness function may comprise a function of the proportion of the nodes of a candidate solution that are shared between paths of the candidate solution.

In general, it is suitable for the value of the fitness function to be higher for a better performing candidate solution and lower for a weaker candidate solution. For example, the fitness function may take values between 0 and 1, where 1 indicates an optimised solution and 0 indicates a very poor candidate solution.

There is no guarantee that the initial set of randomly generated candidate solutions contains the optimum solution. This would be very unlikely. In order to optimise the routing of services, the candidate solutions are evolved at step 1006 using a genetic algorithm towards an optimum solution as follows.

The initial candidate solutions are used as a gene pool that is evolved by an iterative process involving repeated selection of stronger candidate solutions. Thus, with each iteration, the average quality of the candidate solutions increases and it becomes more likely that the gene pool contains the optimum solution.

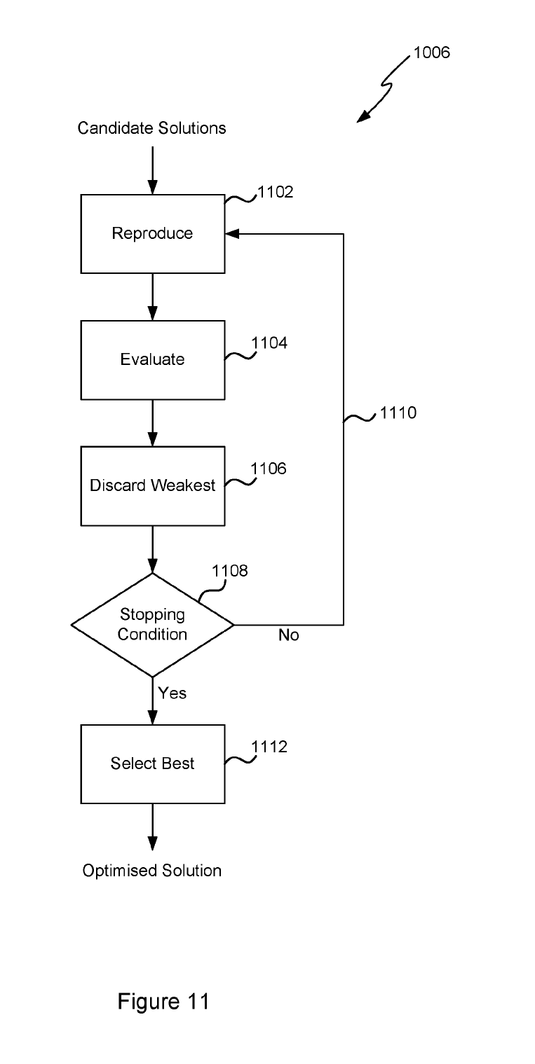

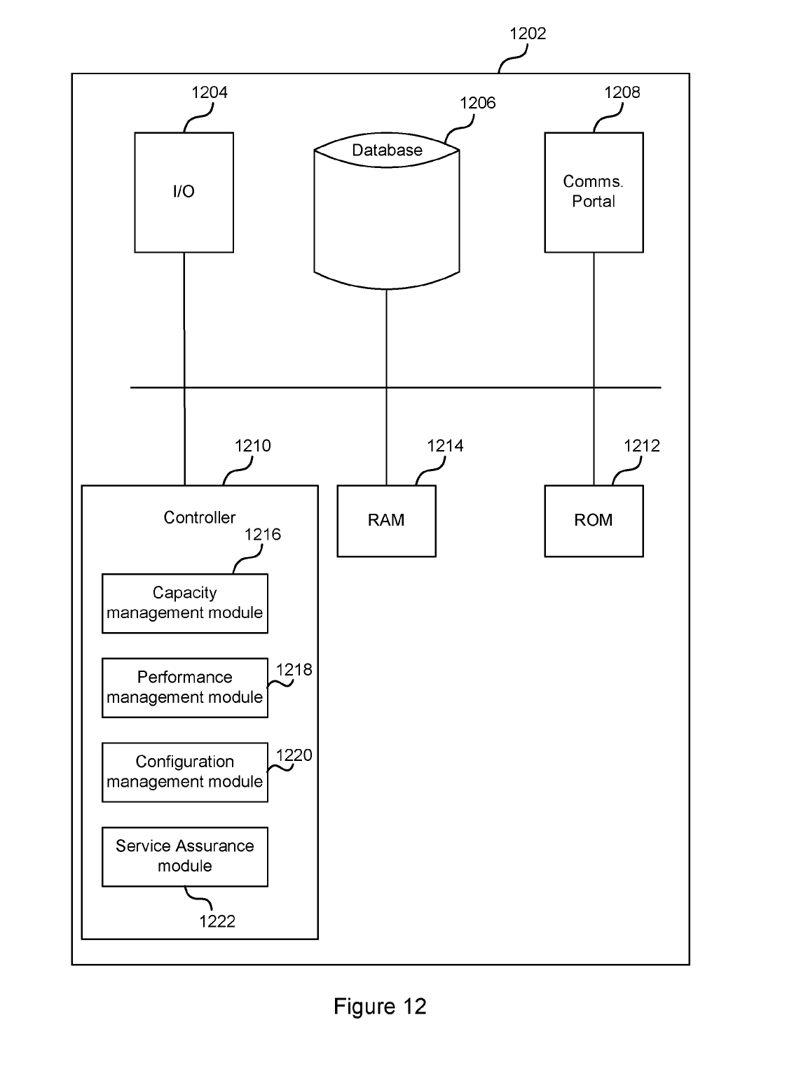

Referring to FIG. 11, the evolution process (step 1006) involves reproducing the candidate solutions at step 1102 using a genetic algorithm to produce one or more ‘child’ candidate solutions from the initial gene pool. The genetic algorithm comprises rules for reproducing the candidate solutions either by mating, mutating or a combination of both.

For example, a pair of child candidate solutions could be created by ‘mating’ two randomly selected parent candidate solutions. The mating process involves swapping corresponding portions of the parent candidate solutions to create two new child candidate solutions. For example, the routes provided by the parent candidate solutions between a particular source node and a particular destination node could be swapped. Alternatively, portions of routes could be swapped, or any other scrambling of the parent solutions could be carried out. Three or more candidate solutions could be scrambled to produce one or more child candidate solutions.

Another method of reproducing is to mutate a parent candidate solution. In this case, a parent candidate solution, which may be randomly selected from the gene pool, is changed in a random, predetermined, or partially random manner. For example, every fifth node of each route could undergo a random change in functionality (e.g. from an optical cross connect to glass through). It will be appreciated that by mutating a single parent candidate solution, a single child candidate solution is created.

The creation of child candidate solutions increases the size of the gene pool of candidate solutions. For example, if the initial set of candidate solutions contains five hundred initial candidate solutions and two child candidate solutions are created, the enlarged gene pool contains five hundred and two candidate solutions. At step 1104 the child candidate solutions are evaluated, for example by calculating a fitness function of the type described above. The candidate solutions of the enlarged gene pool are now ranked in order of the value of their fitness function, and if n child candidate solutions were created in the reproducing step 1102, the weakest n of the enlarged gene pool are discarded (step 1106). Following the example above of five hundred initial candidate solutions and two child candidate solutions, the five hundred and two candidate solutions of the enlarged gene pool are ranked by fitness function value and the weakest two of the enlarged set are discarded. Thus, the total size of the gene pool remains constant over time but the quality of the population improves with cycles of the iteration. At worst, an iteration may produce child candidate solutions that are no better than any of the existing candidate solutions. In that case, the new child candidate solutions will be discarded immediately and the quality of the population, which may for example be expressed as a mean fitness function value, will be unchanged. In any other case an iteration will improve the quality of the population thereby increasing the likelihood that the gene pool contains the optimum routing solution.

The evolution process cycles through iterations by reproducing (step 1102), evaluating (step 1104), and discarding the weakest candidate solutions (step 1106) to maintain a constant population size with each cycle and gradually increase the quality of the population. The gene pool may be said to evolve towards an optimum solution as a result of the bias towards better performing solutions introduced by discarding the weakest candidate solutions in each cycle.

The evolution is stopped when a sufficient number of iterations have been applied to reach a predetermined stopping condition 1108. Two suitable stopping conditions are based on reaching a solution sufficiently close to the optimum solution and reaching a gene pool that is likely to contain the optimum solution.

In the first approach, a fitness function or a performance parameter such as cost of the optimum solution is estimated, and the best candidate solution in the gene pool is compared to the optimum to determine how close the best candidate solution to date is to the optimum solution. If the fitness function or performance parameter of the best candidate solution to date is sufficiently close to that of the optimum value, the stopping condition is satisfied and the evolution is stopped.

For example, if the only performance parameter is cost, the cost of the best solution to date will go down with each iteration, gradually approaching an asymptote which represents the cost of the optimum solution. At some point the cost of the best solution to date will have reached a value within a predetermined percentage, such as 5%, of the optimum cost, at which point the stopping condition is satisfied. After each round of evolution an asymptote is determined. This becomes more reliable with every round of evolution as it is based on more and more data, and can generally be calculated in a meaningful way from, for example, the tenth round onwards. In order to determine an asymptote, the cost improvement as a function of the number of iterations is approximated as a ratio of two polynomials of the same order. Such a rational function, R, may be expressed as follows.

$$R = \frac{{A}_{0} + {A}_{1} \cdot X + {A}_{2} {X}^{2} + … + {A}_{n} {X}^{n}}{1 + {B}_{1} X + {B}_{2} {X}^{2} + … + {B}_{n} {X}^{n}}$$

where X is the number of iterations and A₀, A₁, A₂, . . . , Aₙ, B₀, B₁, B₂, . . . , Bₙ are constants to be evaluated to fit the data. As the number of iterations becomes large the cost tends to the asymptote to a value equal to the ration of the highest term coefficients, Aₙ/Bₙ. Thus, in order to determine the asymptote, the constants A₀, A₁, A₂, . . . , Aₙ, B₀, B₁, B₂, . . . , Bₙ of the polynomials must be computed which can for example be done using a method of least squares. In an example, a best cost to date reaches within 5% of an optimum cost (asymptote) after between 300 and 500 iterations.

In the second approach, the distribution of a fitness function or a performance parameter such as cost is approximated and the value of the fitness function or performance parameter of the best candidate solution to date is compared to the distribution to determine the likelihood that the best candidate solution to date is the optimum solution.

For example, the performance parameter may be cost. The distribution of the cost of all possible routing solutions is approximated based on two assumptions: 1) that the distribution is a normal distribution and 2) that the mean and standard deviation of the initial set of candidate solutions is representative of the mean and standard deviation of all possible candidate solutions. Assumption 2 is justified because the set of initial candidate solutions is generated randomly. Thus, the distribution of the cost of routing solutions is approximated as a normal distribution having a mean and standard deviation the same as the mean and standard deviation of the costs of the initial candidate solutions. The probability that, after any particular number of iterations, the gene pool contains the optimum solution is calculated by iterating the distribution between ˜∞ and the value of the cost of the best solution to date:

P(we have optimum)=∫_{-∞}^{best to date}distribution

Thus, the stopping condition is satisfied when the likelihood of the gene pool containing the optimum routing solution reaches a predetermined percentage, such as 95%.

However, it will be appreciated that a result of 95% based on a small sample size (e.g. a small number of initial candidate solutions) and/or a small number of iterations is likely to be less reliable that a result of 95% based on a large sample size and a large number of iterations. Therefore, a safeguard may be put in place by way of a minimum probability that the optimum solution has not yet been found (where P(optimum not yet found)=1−P(we have optimum)). The minimum probability may comprise a function of the size of the genepool, the number of iterations that have taken place, the standard deviation of the current genepool (which decreases as the genepool evolves), or any combination of the above. For example, the minimum probability that the optimum solution has not yet been found could be defined as:

$${P ( optimum not yet found )}_{min} = \frac{1}{\sqrt{genepool size + number of iterations}}$$

According to this definition of the minimum probability, once the minimum has been reached, further iterations will increase the likelihood that the gene pool contains the optimum but this will happen much more slowly than on previous iterations. This ensures that for a sufficiently small gene pool size, a higher number of iterations may be required before the stopping condition can reached.

Regardless of how the stopping condition is defined, once it is reached the best solution in the gene pool is selected (step 1112) and outputted as the optimised solution as shown in FIG. 11.

Referring to FIG. 12, a device 1202 for implementing an orchestrator according to an embodiment of the invention is shown. The device 1202 comprises an input and output interface element 1204, a database 1206 for storing an instance of a data model describing a network including capacity information as well as service information such as SLAs, a communications portal 1208, a controller 1210, ROM 1212 and RAM 1214. The controller 1210 includes a capacity management module 1216, a performance management module 1218, a configuration management module 1220, and a service assurance module 1222.

In some embodiments the orchestrators are implemented as functions of a computer acting as a global orchestrator. In other embodiments the orchestrators are implemented in separate hardware and may be geographically distributed.

Functions relating to coordinating telecommunications networks may be implemented on computers connected for data communication via the components of a packet data network. Although special purpose devices may be used, such devices also may be implemented using one or more hardware platforms intended to represent a general class of data processing device commonly used so as to implement the event identification functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. energy usage measurements for a time period already elapsed. The software code is executable by the general-purpose computer that functions as the server or terminal device used for coordinating telecommunications networks. In operation, the code is stored within the general-purpose computer platform. At other times, however, the software may be stored at other locations and/or transported for loading into the appropriate general-purpose computer system. Execution of such code by a processor of the computer platform or by a number of computer platforms enables the platform(s) to implement the methodology for coordinating telecommunications networks, in essentially the manner performed in the implementations discussed and illustrated herein.

Those skilled in the art will be familiar with the structure of general purpose computer hardware platforms. As will be appreciated, such a platform may be arranged to provide a computer with user interface elements, as may be used to implement a personal computer or other type of work station or terminal device. A general purpose computer hardware platform may also be arranged to provide a network or host computer platform, as may typically be used to implement a server.

For example, a server includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications.

A user terminal computer will include user interface elements for input and output, in addition to elements generally similar to those of the server computer, although the precise type, size, capacity, etc. of the respective elements will often different between server and client terminal computers. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

Hence, aspects of the methods of coordinating telecommunications networks outlined above may be embodied in programming. Program aspects of the technology may be thought of as “products” or “articles of manufacture” typically in the form of executable code and/or associated data that is carried on or embodied in a type of machine readable medium and/or in a plurality of such media. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the organisation providing coordinating telecommunications networks services into the coordinating telecommunications networks computer platform. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the coordinating telecommunications networks, etc. shown in the drawings. Volatile storage media include dynamic memory, such as main memory of such a computer platform. Tangible transmission media include coaxial cables; copper wire and fibre optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. A system for coordinating a plurality of telecommunications networks, the system comprising:
a first network orchestrator of a first telecommunications network; and a second network orchestrator of a second telecommunications network;
wherein
the plurality of telecommunications networks is described using a data model that is readable by the first and second network orchestrators and that is capable of representing connectedness and one or more of capacity and demands for service on the networks,
the first network orchestrator is configured to transmit a first request expressed in terms of the data model for network resources to the second network orchestrator, and
the second network orchestrator is configured to receive the first request for network resources, automatically determine that the requested network resources can be provided, and automatically transmit to the first network orchestrator a confirmation expressed in terms of the data model that the network resources of the first request can be provided.

2. A system according to claim 1, wherein at least two of the telecommunications networks are different types of telecommunications networks.

3. A system according to claim 1, wherein the data model comprises a data-driven network model for describing a telecommunications network.

4. A system according to claim 3, wherein the data-driven network model comprises vectors and/or matrices for describing properties of the network.

5. A system according to claim 4, wherein the data-driven network model comprises a description of network connectedness defined in terms of a connectedness matrix of unidirectional link identification by node identification in which matrix cells are populated by binary values.

6. A system according to claim 4, wherein the data-driven network model comprises a description of network cost defined in terms of a cost of links matrix of unidirectional link identification by cost in which matrix cells are populated by cost values.

7. A system according to claim 1, wherein the data model comprises a data-driven capacity model for describing capacity of a telecommunications network.

8. A system according to claim 7, wherein the data-driven capacity model comprises a description of network capacity defined in terms of a capacity matrix of unidirectional link identification by bandwidth in which matrix cells are populated by bandwidth values.

9. A system according to claim 1, wherein the data model comprises a data-driven service model for describing service demands on a telecommunications network.

10. A system according to claim 9, wherein the data-driven service model comprises a description of demands for service defined in terms of a demand matrix of start node identification by destination node identification in which matrix cells are populated by bandwidth values.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. An orchestrator of a telecommunications network, the orchestrator being configured to: transmit a request for network resources to an orchestrator of another telecommunications network;
receive from the orchestrator of the other telecommunications network a confirmation that the network resources of the request can be provided; and
automatically control one or more components of the telecommunications network for transmitting data through the networks based on the confirmation.

31. (canceled)

32. A method of coordinating a plurality of telecommunications networks, the method comprising:
a first network orchestrator of a first telecommunications network transmitting a first request expressed in terms of a data model for network resources to a second network orchestrator of a second telecommunications network;
the second network orchestrator receiving the first request for network resources and automatically determining that the requested network resources can be provided;
the second network orchestrator automatically transmitting to the first network orchestrator a confirmation expressed in terms of the data model that the network resources of the first request can be provided,
wherein the data model describes the plurality of telecommunications networks and is readable by the first and second orchestrators and is capable of representing connectedness and one or more of capacity and demands for service on the networks.

33. A method according to claim 32, wherein at least two of the telecommunications networks are different types of telecommunications networks.

34. A method according to claim 32, wherein the data model comprises a data-driven network model for describing a telecommunications network.

35. A method according to claim 34, wherein the data-driven network model comprises vectors and/or matrices for describing properties of the network.

36. A method according to claim 35, wherein the data-driven network model comprises description of network connectedness defined in terms of a connectedness matrix unidirectional link identification by node identification in which matrix cells are populated by binary values.

37. A method according to claim 35, wherein the data-driven network model comprises a description of network cost defined in terms of a cost of links matrix of unidirectional link identification by cost in which matrix cells are populated by cost values.

38. A method according to claim 32, wherein the data model comprises a data-driven capacity model for describing capacity of a telecommunications network.

39. A method according to claim 38, wherein the data-driven capacity model comprises a description of network capacity defined in terms of a capacity matrix of unidirectional link identification by bandwidth in which matrix cells are populated by bandwidth values.

40. A method according to claim 32, wherein the data model comprises a data-driven service model for describing service demands on a telecommunications network.

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)
